(19) United States
(12) Patent Application Publication
(10) Pub. No.: US 2021/0184350 A1
(43) Pub. Date: Jun. 17, 2021

(54) PASSIVE BEAM MECHANICS TO REDUCE GRATING LOBES

(71) Applicant: MANO D. JUDD, Heath, TX (US)

(72) Inventor: MANO D. JUDD, Heath, TX (US)

(21) Appl. No.: 17/113,550

(22) Filed: Dec. 7, 2020

Related U.S. Application Data
(60) Provisional application No. 62/947,338, filed on Dec. 12, 2019.

(51) Int. Cl. H01Q 3/26; G01S 7/40

(52) U.S. Cl. CPC H01Q 3/267; G01S 7/40

(57) ABSTRACT

Over-sampling of the received signal above the traditional Nyquist Sampling Rate, using a High Speed Analog to Digital Converter (ADC) is used to produce additional vector signal samples that then synthetically generate “fill in” antennas, at the vacant or “hole” positions in Phased Arrays systems. Benefits of this technology include elimination of grating lobes, increased directed array gain, as well as reduction of sidelobe energy. This technique can also be used to, in addition to, the (Passive Beam Mechanics #U.S. Provisional Patent No. 62/895,574) technology used to increase the effective size of the original (real, versus synthetic) antenna or array, which results in the construction or generation of a narrower beamwidth. Major applications for the technology include Radar and RF Communications. It should be noted that this technology is also applicable for use in Acoustics, such as underwater detection and location of signals, or for (air) acoustic communications.

The present application claims priority to the earlier filed provisional application having Ser. No. 62/947,338, and hereby incorporates subject matter of the provisional application in its entirety.

### BACKGROUND

In traditional RADAR systems, Communications systems, Direction Finding systems, and other applications which use directive antennas or phased arrays, it is often desirable that the transmitting and/or receiving array has elements that are closely spaced and contains antenna elements with no gaps or holes, thus restricting adjacent antenna element spacing to less than a half wavelength at the operational carrier frequency. Half wavelength spacing, or less, is desired for scan angles up to 180 degrees off of array broadside or boresight. For small scan angles, a look direction near array broadside, antenna element spacing can be up to a full wavelength in dimension.

For adjacent elements with spacing greater than the above prescribed spacing distances, these adjacent spacing gaps or “holes” generate grating lobes in the array. These grating lobes can often have equivalent gain to the main (desired) beam, which can lead to less than optimal array performance, for numerous and different applications. This technology also applies to acoustic arrays, in air or water.

### BRIEF SUMMARY OF THE INVENTION

In this invention, over-sampling of the received signal above the traditional Nyquist Sampling Rate, using a High Speed Analog to Digital Converter (ADC) is used to produce additional vector signal samples that are used to construct higher dimensional Signal Data Vectors and Calibration Data Vectors, that are used to synthetically generate “fill in” antennas, at the vacant or “hole” positions in Phased Arrays systems.

Note, this technique can also be used to, in addition to, the (Passive Beam Mechanics, (U.S. Provisional Patent No. 62/895,574) technology used to increase the effective size of the original (real, versus synthetic) antenna or array, which results in the construction or generation of a narrower beamwidth.

Major applications for the technology include Radar and RF Communications. It should be noted that this technology is also applicable for use in Acoustics, such as underwater detection and location of signals, or for (air) acoustic communications.

### BRIEF DESCRIPTION OF THE DRAWINGS

FIG. 1 shows a Conventional RF Downconversion and Sampling Mechanism.

FIG. 2 illustrates an Interferometric model for the Real Array.

FIG. 3 presents ADC outputs, in time, for the first two real antennas (sensors).

FIG. 4 shows two antenna model shown in Space-Time.

FIG. 5 illustrates a linear array of antennas, with two vacant positions (“Antenna Holes”).

FIG. 6 presents a Space-Time representation of filling the antenna “hole” at position #5.

FIG. 7 shows a Space-Time representation of filling the Antenna “hole” at position #6.

FIG. 8 illustrates an example case of 6 Real antennas and 8 vacant antenna positions (“holes”).

FIG. 9 shows the Array Factor or Radiation Pattern for the 6 Real antennas and 8 vacant antenna positions.

FIG. 10 illustrates the results after the array filling technique.

FIG. 11 shows the Array Factor or Radiation Pattern for the synthesized array, with all vacant antenna positions (“holes”) filled.

FIG. 12 shows a combination of the fill-in technique with the Passive Beam Mechanics technique.

### DETAILED DESCRIPTION AND BEST MODE OF IMPLEMENTATION

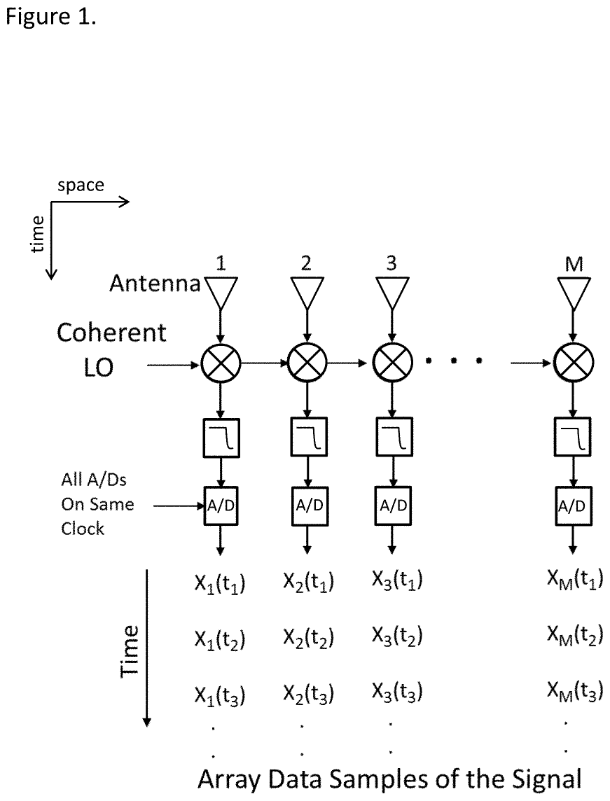

The Diagram in FIG. 1 shows a Conventional shows a conventional RF downconversion and sampling system, used in most RF Array applications. This consists of a multiplicity of M antennas, M RF Conversion/mixing blocks, each followed by a Low-Pass RF or IF Filter and finally an Analog to Digital Converter (ADC) for each RF channel. Each channel, i=1, . . . , M, generates a sample of the incident (and downconverted) signal, which can be modeled as a data vector:

x(t)=s(t)·a(θ,℠,f)+n(t)

Where

s(t)=the baseband signal, received and downconverted, on each i channel

a(θ,ϕ,f)=array steering vector, for a far field signal at azimuth angle, θ, elevation angle, ϕ, and carrier frequency f.

n(t)=noise vector, as a function of time.

In this model, the noise is assumed uncorrelated from sensor (antenna) to sensor, as well as uncorrelated from one (time) snapshot or sample to the next.

It is assumed at this point, that the effective sample rate has also been decimated such that the effective sample rate is twice the bandwidth of the desired signal, s(t). We therefore assume that the decimated data rate, equivalent to twice the desired signal bandwidth, is:

$${f}_{s} = \frac{1}{Δ t}$$

where Δt is the time duration (or period) of a single ADC sample or snapshot. Note, that fs can be greater than twice the signal bandwidth of s(t), but should not be less than twice the bandwidth of s(t).

According to conventional signal processing nomenclature, shown, in FIG. 1, the first component of the data vector, x(t), would be x₁(t₁). This represents the converted signal from the 1st antenna (channel), at time t₁. The time stamp, t₁, simply represents an initial start time for the data vector, and is relative across all antennas. For the same antenna channel, the next data sample, x₁(t₂), is generated at time t₂=t₁+Δt. For the ith antenna, at time t_{N}, the component of the data vector would be x₁(t_{N})=x₁(t₁+(N−1)Δt). Thus, the column showing the components of each x₁(t_{N}) is simply the ADC output corresponding to sample durations for each Δt.

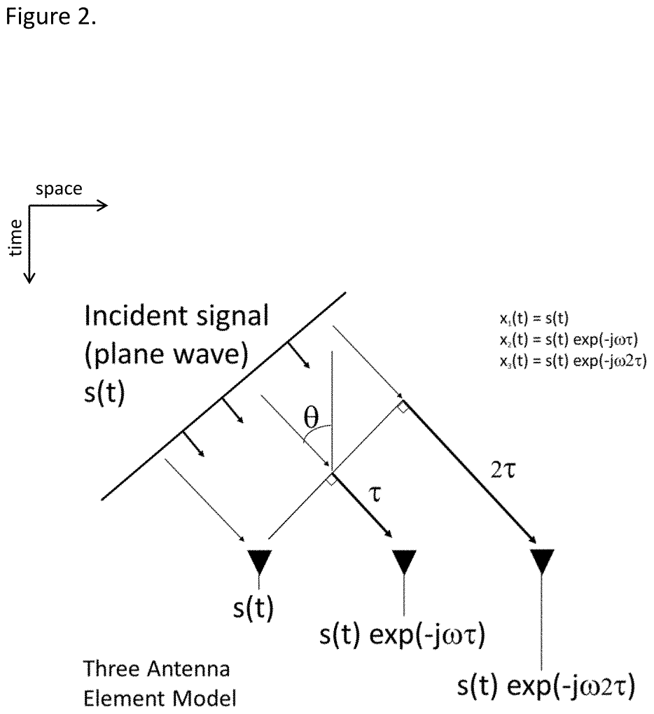

The diagram in FIG. 2 shows an Interferometric model for three (M=3) real antennas. A Far Field plane wave is shown on the left, which is incident in the direction of θ offset to the normal from the array. Assume that the 1st antenna is on the left. Therefore, after RF downconversion, the relative signal captured by this antenna would be x₁(t)=s(t). Note, the steering vector delay component has been omitted for this antenna channel, since we have normalized all antenna channels to antenna channel #1.

For all remaining relationships and diagrams, the noise vector, n(t), will be omitted and assumed to be minor, the elevation spatial dimension will be assumed to be zero, and the carrier frequency common across all elements. Therefore, the steering vector nomenclature, for the delays due to an incident signal from azimuth θ, elevation ϕ, and frequency f, can simply be expressed as:

a(θ,ϕ,f)⇒a(θ)

Note that the model in the single spatial (azimuth) dimension can be extended to both spatial dimensions, in both azimuth and elevation, without any loss of generality. Additionally, the nomenclature, for the received response from antenna #2, at time t, can be expressed as:

$$\begin{matrix}{x}_{2} ( t ) = s ( t ) \cdot {a}_{2} ( θ ) \\ = s ( t ) \cdot {e}^{- j ωτ}\end{matrix}$$

Where the steering vector component a₂(θ) has been substituted for the complex phase delay, e^{-jωt}. Note, that the interferometric delay value, τ, for the linear array model can be expressed as:

$$τ = \frac{d \cdot sin ( θ )}{c}$$

Where

d=spacing (length) between antennas (sensors) in the linear array, and

C=speed of light.

The response for the 3rd antenna (sensor) can be therefore expressed as:

$$\begin{matrix}{x}_{3} ( t ) = s ( t ) \cdot {a}_{3} ( θ ) \\ = s ( t ) \cdot {e}^{- j ω2τ}\end{matrix}$$

The first novelty of the invention now includes an ADC rate at a much higher sampling rate. This rate will be represented as P times the original rate of fₛ, or:

$$\begin{matrix}{f}_{ss} = P \cdot {f}_{s} \\ = P \cdot \frac{1}{Δ t}\end{matrix}$$

Note also that the new sample period, Δtₛ, can be expressed as a function of the original sample period, Δt, as:

$$Δ {t}_{s} = \frac{Δ t}{P}$$

That is, the sample period for the over-sampled rate is P times shorter (smaller) than the original (Nyquist) rate.

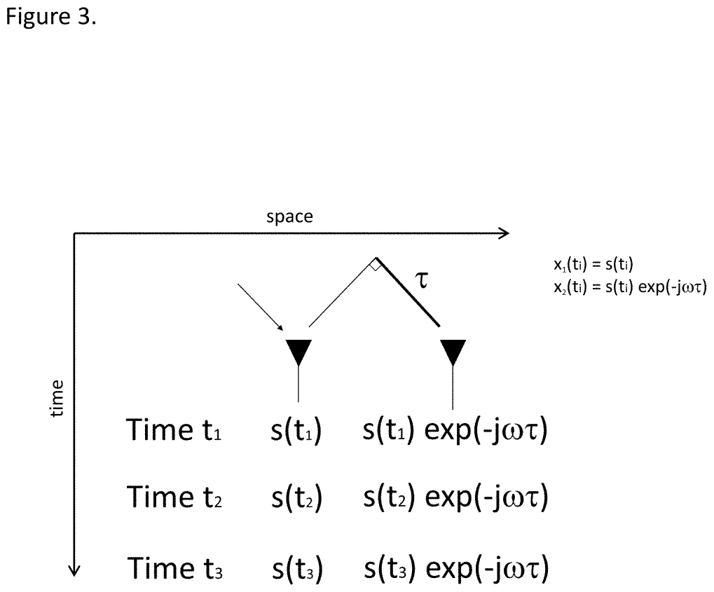

FIG. 3 shows the ADC outputs for the first two antennas, shown as columns versus time, but now with the time samples corresponding to the over-sampled rate, e.g. t₂=t₁+Δtₛ.

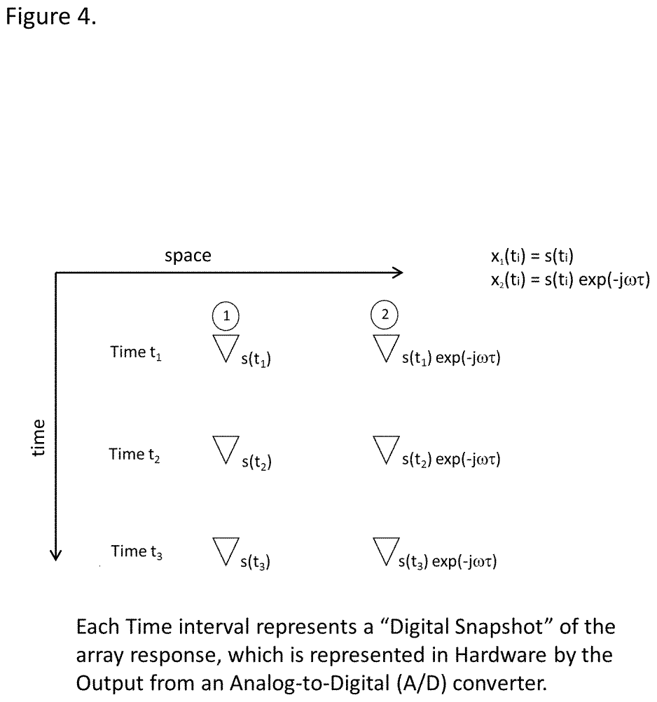

This can be similarly represented in Space-Time as antennas locations in time, as shown in FIG. 4.

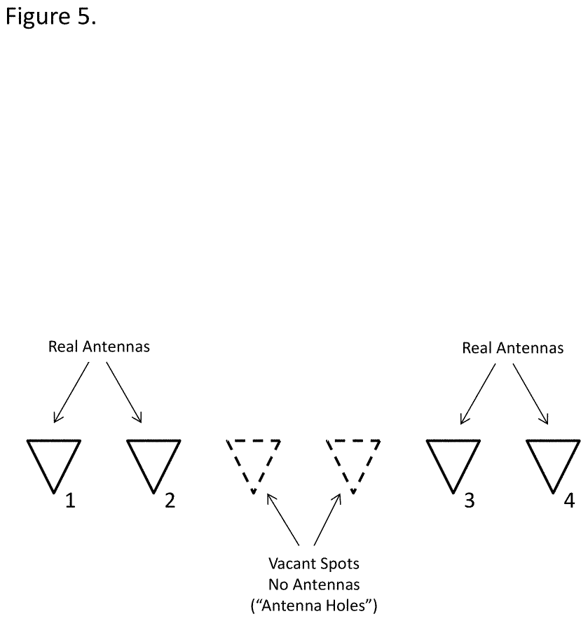

At this point, the Applicant will re-introduce the problem of vacant antenna positions or holes. Assume the following linear array of antennas, as shown in FIG. 5.

Antennas #1, 2, 3 and 4 are all real antennas. Assume the spacing between antennas #1 and #2, as well as antennas #3 and #4 are on the order of a half-wavelength, at the carrier frequency f. Therefore the distance between antenna #2 and antenna #3 is roughly 3 times a half-wavelength, or roughly 1.5 wavelengths. Therefore, the response of this array will produce unwanted Grating Lobes in the array radiation pattern. Note, without loss of generality, this can be extended to a near infinite number of array conditions or array topographies.

Referring again to the example in FIG. 5, it would be desired to have two (more) antennas, in the positions shown by the dotted line antennas. In these two positions, there are no real (actual) antennas, and thus can be denoted as “Antenna Holes”. This can be due to any number of physical, system, or even cost constraints. In terms of Radar performance, these two vacant positions can highly reduce the effectiveness and operation of the Radar system. What is desired is a method that can form synthetic antennas, at these two desired positions, from the data from the real antennas.

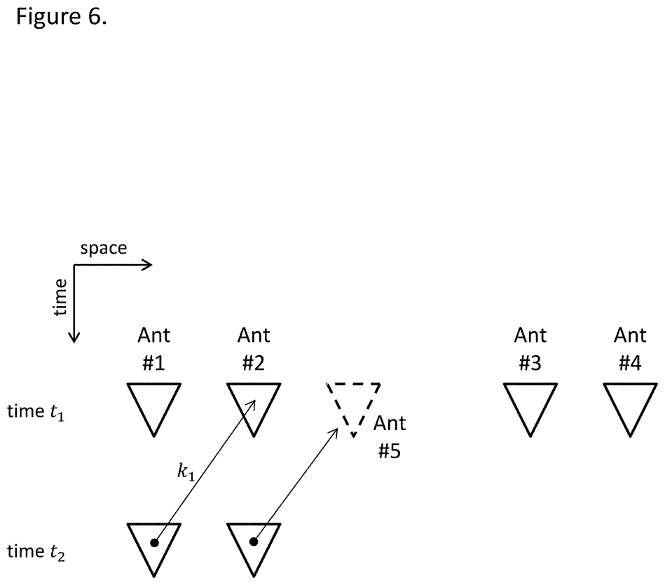

The solution is similar to the method developed in application (Passive Beam Mechanics #U.S. Provisional Patent No. 62/895,574) using algebraic combinations of samples from real antennas (providing space positions), and oversampled in time (time positions), resulting in manipulation of “Space-Time”. However, rather than extending an array, this technique fills in “holes” or gaps in the P=1 array. FIG. 6 shows the Space-Time diagram of the real antennas (shown horizontally) and sampled in time (shown vertically). This is the same array as in FIG. 4, however with the vertical elements as different antenna responses due to sampling different instances in time.

To generate a new antenna, at the “hole” or position #5 as shown on the horizontal row (in FIG. 6), representing a time snapshot of all real elements at time t₁, we invoke the shifting element that correlates the response of antenna #1 at time t₂, to the antenna response of antenna #2 at time t₁, in the oversampled data. This shift can be represented as:

$${k}_{1} \cdot {x}_{1} ( {t}_{2} ) = {x}_{2} ( {t}_{1} )$$

$$Or$$

$${k}_{1} = \frac{{x}_{2} ( {t}_{1} )}{{x}_{1} ( {t}_{2} )}$$

It should be noted that while U.S. Pat. No. 7,250,905 B2 (date Jul. 31, 2007), abandoned, “Virtual Antenna Technology (VAT) and Applications”, describes a mechanism for the generation of virtual antennas, in a patch array, this patent does not mention Oversampling, or filling in “holes” in an array.

If we now multiple, by k₁, the value of antenna #2 at time period t₂ in the oversampled data, we can then construct synthetic antenna, #5 (shown in FIG. 6), via:

$$\begin{matrix}{k}_{1} \cdot {x}_{2} ( {t}_{2} ) = \frac{{x}_{2} ( {t}_{1} )}{{x}_{1} ( {t}_{2} )} \cdot {x}_{2} ( {t}_{2} ) \\ = \frac{s ( {t}_{1} ) {e}^{- j ωτ}}{s ( {t}_{2} )} \cdot s ( {t}_{2} ) {e}^{- j ωτ} \\ = s ( {t}_{1} ) {e}^{- j ω2τ}\end{matrix}$$

Which is exactly the value we would expect to obtain if we had a real antenna at position #5. Note, this synthesis has been obtained via simple multiply and add operations of the existing over sampled data.

This value for the synthetic antenna element #5 can now be added to the original data vector set, for time sample #1, where

x(t₁)=[x₁(t₁), x₂(t₁)] is the original data vector, consisting of the first two antennas, for time stamp t₁. Notice that this is a 2×1 vector, or a vector of dimension value 2. The new synthesized data vector, including the data sample obtained from the oversampled data set, would be:

$$\begin{matrix}{\underline{x}}_{s} ( {t}_{1} ) = [ {x}_{1} ( {t}_{1} ) , {x}_{2} ( {t}_{1} ) , {x}_{5} ( {t}_{1} ) ] \\ = [ s ( {t}_{1} ) , s ( {t}_{1} ) {e}^{- j ωτ} , s ( {t}_{1} ) {e}^{- j ω2τ} ]\end{matrix}$$

We can see that this new, increased dimensional, data vector is extremely representative of an array of 3 real sensors.

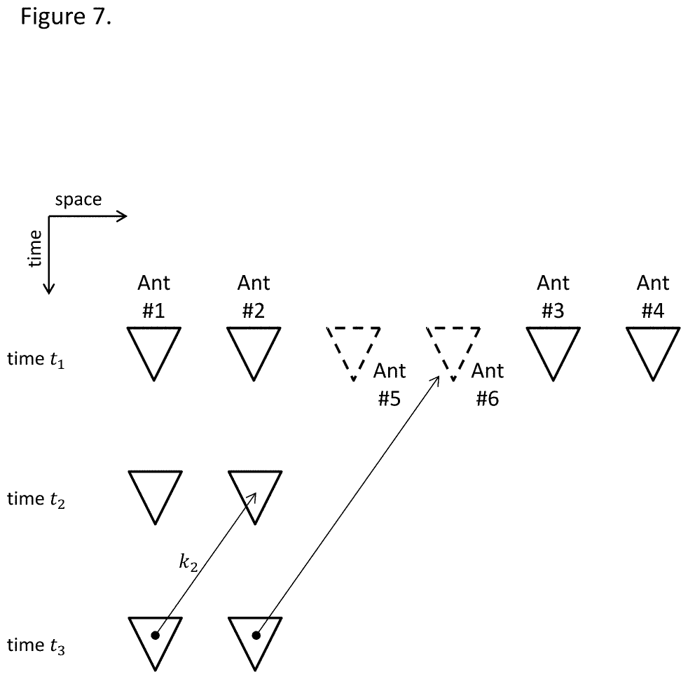

To generate a new antenna, at the second “hole” or position #6 as shown on the horizontal row, we extend this process, using the diagram in FIG. 7.

Similar to the first shift using k₁, we now enable a second shift, k₂. Again, these are all using oversampled data points.

This shift can be represented as:

$${k}_{2} \cdot {x}_{1} ( {t}_{3} ) = {x}_{2} ( {t}_{2} )$$

$$Or$$

$${k}_{2} = \frac{{x}_{2} ( {t}_{2} )}{{x}_{1} ( {t}_{3} )}$$

If we now multiple, by k₁ and k₂, the value antenna #2 at time period t₃, in the oversampled data, we can then construct synthetic antenna, #6 (shown in FIG. 6), via:

$$\begin{matrix}{k}_{1} \cdot {k}_{2} \cdot {x}_{2} ( {t}_{3} ) = \frac{{x}_{2} ( {t}_{1} )}{{x}_{1} ( {t}_{2} )} \cdot \frac{{x}_{2} ( {t}_{2} )}{{x}_{1} ( {t}_{3} )} \cdot {x}_{2} ( {t}_{3} ) \\ = \frac{s ( {t}_{1} ) {e}^{- j ωτ}}{s ( {t}_{2} )} \cdot \frac{s ( {t}_{2} ) {e}^{- j ωτ}}{s ( {t}_{3} )} \cdot s ( {t}_{3} ) {e}^{- j ωτ} \\ = s ( {t}_{1} ) {e}^{- j ω3τ}\end{matrix}$$

Which is exactly the value we would expect to obtain if we had a real antenna at position #6.

Recall, that k₁ and k₂ are simply constructed from (known) sampled values of real antennas.

This value, for synthesized antenna element #6, can now be added to the original data vector set, for time sample #1, where

x(t₁)=[x₁(t₁), x₂(t₁)] is the original data vector, consisting of the first two antennas, for time stamp t₁. Notice that this is a 2×1 vector, or a vector of dimension value 2. The new synthesized data vector, including the data samples obtained from the oversampled data set, would be:

$$\begin{matrix}{\underline{x}}_{s} ( {t}_{1} ) = [ {x}_{1} ( {t}_{1} ) , {x}_{2} ( {t}_{1} ) , {x}_{5} ( {t}_{1} ) , {x}_{6} ( {t}_{1} ) ] \\ = [ s ( {t}_{1} ) , s ( {t}_{1} ) {e}^{- j ωτ} , s ( {t}_{1} ) {e}^{- j ω2τ} , s ( {t}_{1} ) {e}^{- j ω3τ} ]\end{matrix}$$

Finally, we add the sampled response from real antennas #3 and #4, and we have:

$$\begin{matrix}{\underline{x}}_{s} ( {t}_{1} ) = [ {x}_{1} ( {t}_{1} ) , {x}_{2} ( {t}_{1} ) , {x}_{5} ( {t}_{1} ) , {x}_{6} ( {t}_{1} ) , {x}_{3} ( {t}_{1} ) , {x}_{4} ( {t}_{1} ) ] \\ = [ s ( {t}_{1} ) , s ( {t}_{1} ) {e}^{- j ωτ} , s ( {t}_{1} ) {e}^{- j ω2τ} , s ( {t}_{1} ) {e}^{- j ω3τ} , s ( {t}_{1} ) {e}^{- j ω4τ} , s ( {t}_{1} ) {e}^{- j ω5τ} ]\end{matrix}$$

which would be equivalent to the vector of 6 real (actual) antennas, in a linear array. Without loss of generality, it should be evident that antennas #1 and #2 could also fill in vacant holes to the left of the antenna pair (#1 and #2) as well as to the right, as just shown. Additionally, for the example array above, these same vacant holes could have been filled by antennas #3 and #4 as well, by producing the k-shift to the left, instead of to the right.

It should also be noted, as a reminder, that this technique currently only works in the receive mode.

To fill in vacant antenna positions or holes requires the following:

1) Oversampled data from the [time synchronized] Analog to Digital Converters.

2) Real Antenna pairs, separated by a distance d.

These two conditions enable the generation of synthesized antenna elements, in vacant antenna positions (“holes”) that are an integer multiple of the distance d, from either end antenna of the real antenna pair.

Without loss of generality, this method can be both to fill in and also be used to generate much larger effective arrays.

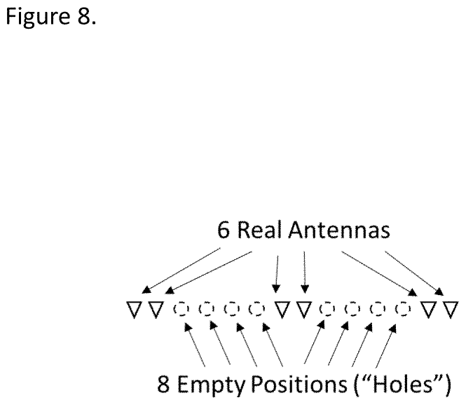

A broader example of the system and simulated (computer modeled) performance is shown as follows, in FIGS. 8 through 12.

We start with an array of 6 real sensors, and 8 vacant antenna positions (“holes”) as shown in FIG. 8. Each of the antenna pairs shown in this array are spaced by half a wavelength, at the carrier frequency. Therefore, the gap between the two antennas on the far left to the two antennas in the center is 5 half-wavelengths, or 2.5 wavelengths.

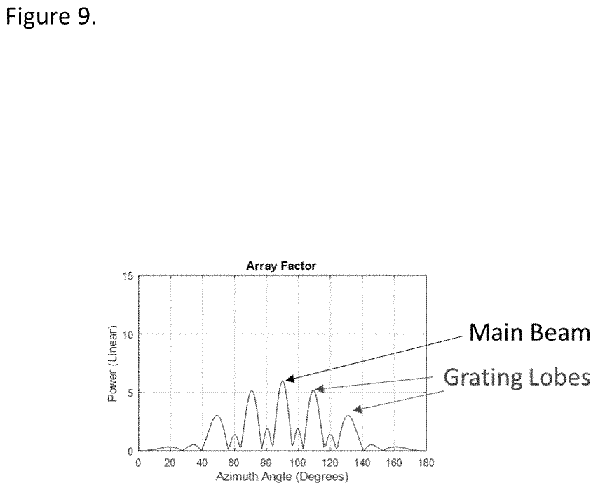

The Radiation Pattern for the (real) array is shown in FIG. 9. This is the pattern for the main beam steered (directed) exactly at array broadside, or boresight. Notice the four large grating lobes to the sides of the main beam. For a Radar system, this would produce many detection false alarms as well as reducing the angular precision of the array by a large amount.

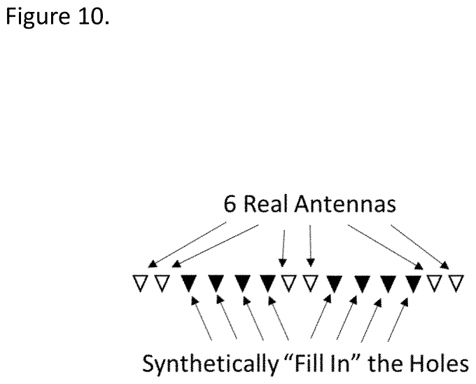

In FIG. 10, the Array Filling technique, as detailed above, is used to fill in the “holes” and generate eight (8) synthetic antennas.

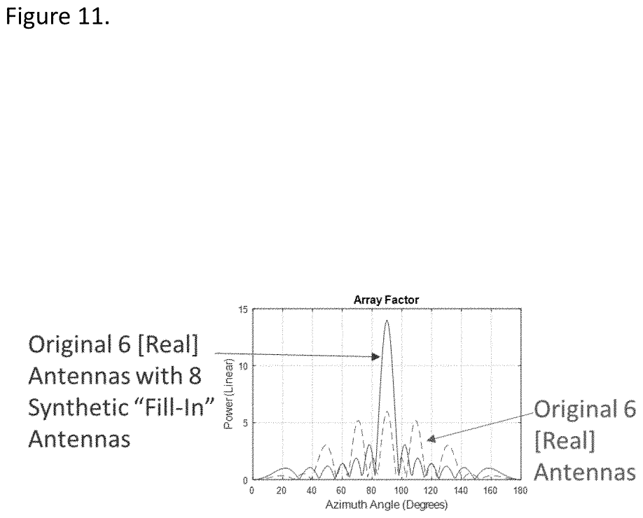

The plot in FIG. 11 shows the radiation pattern of the synthetic array, with all fill in positions (solid line), as compared to the original array with vacant antenna positions (dotted line). Notice:
an increase in directive gain
elimination of all Grating Lobes, and
reduction of sidelobe magnitudes.

In addition to filling in holes, the P degrees of Freedom can also be used to both fill in holes (vacant antenna positions) and then also to extend the size of the array, as demonstrated in Passive Beam Mechanics (U.S. Provisional Patent No. 62/895,574).

Here, the same 6 Real antenna array, with 8 Holes (Vacant Antenna positions) is filled, as per FIGS. 10 and 11, but can then be used with P=64 (Oversampling rate) to produce a much larger synthesized array, composed of roughly 64*(14−1) antenna elements; both real and synthetic, also with no grating lobes. This uses the Passive Beam Mechanics technology, U.S. Provisional Patent No. 62/895,574.

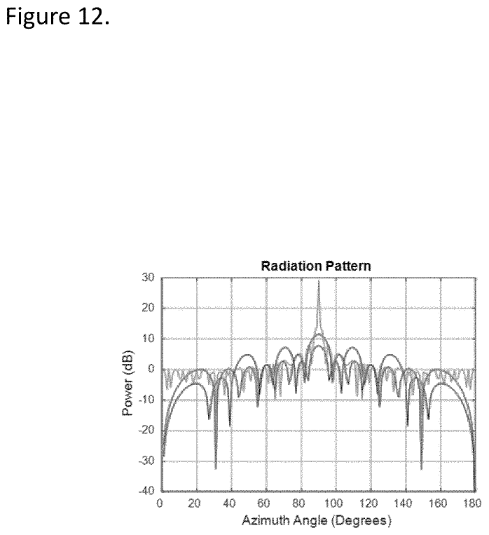

The Radiation Pattern of this array is shown in FIG. 12.

We can see that without loss of generality, that we can continue this process, for very high P values. That is, each value of P enables us to fill-in at least one vacant antenna position. The limit is the maximum rate of the ADC, for a given number of desired bits, or Effective Number of Bits (ENOB). That is, if a 16-bit response is desired, the original signal bandwidth is 1 MHz, and the maximum ADC rate is 200 MSPS (which results in a maximum sampled bandwidth of 100 MHz), the maximum P value will be 100 MHz/1 MHz=100. This can be expressed as:

$${P}_{max} = \frac{\frac{1}{2} \cdot Max ADC Rate}{Signal Bandwidth}$$

It should be noticed that nowhere in any derivation has the patent author used known positions or velocities. That is, the technique is “blind”, and does not require or use motion or knowledge of motion of the array. In fact, this technique can be used for arrays and platforms with no motion, at all.

Finally, it should be noted that generation of the Synthetic Data Vector is almost instantaneous, and requires no adaptive process or processing.

Key Novelties and Benefits of the invention:

Key Novelties:
Generation of synthesized fill-in antennas, for vacant positions in an array
Oversampled data from the [time synchronized] Analog to Digital Converters. (The effective Fs greater than the minimum Nyquist Rate).
Requires Real Antenna pairs, separated by a distance d.
enables the generation of synthesized antenna elements, in vacant antenna positions (“holes”) that are an integer multiple of the distance d, from either end antenna of the real antenna pair.

Note, this technique can also be used to, in addition to, the (Passive Beam Mechanics #U.S. Provisional Patent No. 62/895,574) technology used to increase the effective size of the original (real, versus synthetic) antenna or array, which results in the construction or generation of a narrower beamwidth.

Key Benefits:
Elimination of Grating Lobes (Primary Benefit)
an increase in directive gain
a reduction of sidelobe magnitudes.

### REFERENCES (INCORPORATED HEREIN BY REFERENCE)

M. Judd, “Passive Beam Mechanics,” U.S. Patent Application No. 62/895,574.
M. Judd, “Virtual Antenna Technology (VAT) and Applications,” U.S. Pat. No. 7,250,905 B2.

What is claimed is:

1. A system wherein a multiplicity of M antennas, M RF Conversion/mixing blocks, each followed by a Low-Pass RF or IF Filter and finally an Analog to Digital Converter (ADC) for each RF channel, where each channel, i=1, . . . , M, generates a sample of the incident (and downconverted) signal, which can be modeled as a data vector x(t)=s(t)·a(θ,ϕ,f)+n(t), wherein
a. s(t)=the baseband signal, received and downconverted, on each i channel, and
b. a(θ,ϕ,f)=array steering vector, for a far field signal at azimuth angle, θ, elevation angle, ϕ, and carrier frequency f, and
c. n(t)=noise vector, as a function of time, and
d. using over-sampling of the received signal above the traditional Nyquist Sampling Rate, a High Speed Analog to Digital Converter (ADC) is utilized to produce additional vector signal samples that are used to construct higher dimensional Signal Data Vectors and Calibration Data Vectors, that are applied in a way to synthetically generate “fill in” antennas, at the vacant or “hole” positions in Phased Arrays systems.

2. The system of claim 1 which operates at an ADC rate at a higher sampling rate than the twice the signal bandwidth, which is P times the original rate of fₛ or
$${f}_{ss} = P \cdot f = P \cdot \frac{1}{Δ {t}_{s}} .$$

3. The system of claim 1 wherein the new sample period, Δtₛ is to be expressed as a function of the original sample period, Δt, as
$$Δ {t}_{s} = \frac{Δ t}{P} ,$$
which is P times shorter than the original Nyquist rate.

4. The system of claim 1 wherein the operational method is similar to the method developed in application (Passive Beam Mechanics #U.S. Provisional Patent No. 62/895,574) using algebraic combinations of samples from real antennas (providing space positions), and oversampled in time (time positions), resulting in manipulation of “Space-Time”, however, rather than extending an array, this technique fills in “holes” or gaps in the P=1 array.

5. The system of claim 1 wherein a single or multiplicity of shifted elements, that correlates the response of a reference antenna in the array at time t₂, to the antenna response of another antenna in the array at time t₁ in the oversampled data stream, is used to generate a shift factor k, that is then used to generate a new antenna or multiplicity of antennas at the hole position.

6. The system of claim 1 wherein the technique can also be applied to, not only the Passive Beam Mechanics, (U.S. Provisional Patent No. 62/895,574) technology used to increase the effective size of the original (real, versus synthetic) antenna or array, resulting in the construction or generation of a narrower beamwidth, but this shift can also be performed with virtually any set of antennas in the real array, and to any over sampled time period from 2 to P.

7. The system of claim 1 wherein the technique is blind and does not require motion of the array or coordinated motion and location knowledge of the real elements of the array.

8. The system of claim 1 wherein an increased dimensional data vector is generated by adding the synthesized antenna components to the original real data vector, which now represents the original array data stream plus data stream elements of new antennas which fill gaps or holes.

9. The system of claim 1 wherein the method operates in the receive mode and uses oversampled data from the time synchronized Analog to Digital Converters and exploits oversampled data from real antenna pairs.

10. The system of claim 1 wherein the resulting array radiation patterns will observe fewer or no major sidelobes with gain levels equivalent to the main lobe thereby reducing radar false alarms.

11. The system of claim 1, wherein the technique also generates an increase in the directive gain of the original real array.

12. The system of claim 1, wherein the method which can be used in conjunction with the Passive Beam Mechanics technology, U.S. Provisional Patent No. 62/895,574, to both reduce grating lobes as well as to narrow the received beamwidth.
